(19) United States
(12) Patent Application Publication
(10) Pub. No.: US 2016/0125319 A1
(43) Pub. Date: May 5, 2016

(54) BEACON DEVICE CONFIGURATION AND MONITORING

(71) Applicants: Taylor Drake Morgan, New York, NY (US); Eric Josef Goetschalckx, Atlanta, GA (US)

(72) Inventors: Taylor Drake Morgan, New York, NY (US); Eric Josef Goetschalckx, Atlanta, GA (US)

(21) Appl. No.: 14/529,917

(22) Filed: Oct. 31, 2014

(51) Int. Cl. G06Q 10/02; G06Q 20/10; G06Q 30/02; G06Q 20/32; H04B 17/11; H04W 4/00

(52) U.S. Cl. CPC G06Q 10/02; H04B 17/11; H04W 4/008; G06Q 30/0267; G06Q 20/3224; G06Q 20/10

(57) ABSTRACT

Various embodiments each include at least one of systems, methods, devices, and software for beacon device configuration and monitoring, such as with regard to BLUETOOTH® beacon devices. One example embodiment is a method that includes receiving, by a mobile device transceiver from a beacon device, a radio signal including encoded beacon device identifying data. The method then determines, on the mobile device within a mobile device app, whether the beacon device is configured in a backend system for a facility at which the beacon device is deployed. When the beacon device has not been configured, the method includes presenting a beacon device configuration interface within which configuration options are presented and configuration input is received to form configuration data that is stored to the backend system.

### BACKGROUND INFORMATION

Radio beacons, such as BLUETOOTH® beacon devices, are gaining popularity in many settings. Such beacon devices are used to enable mobile devices to obtain data from which a current location can be determined relative to either one or more known locations or an actual location with a certain degree of accuracy. Beacon devices may be deployed such that their positioning capabilities may be leveraged for several purposes. However, beacon device configuration to date has been manual. Administrators are required to manually create and update data in backend systems that associates particular beacon devices to specific locations or in association with other specific devices. As with any manual process, this is prone to error. Further, configuration of a beacon device is not within the skills of a typical employee. Thus, specially trained personnel must be dispatched to different locations where configuration and issue resolution is needed. This can result in lengthy system outages and frustration of customers desiring to utilize beacon device enabled solutions and functionality.

### SUMMARY

Various embodiments each include at least one of systems, methods, devices, and software for beacon device configuration and monitoring, such as with regard to BLUETOOTH® beacon devices.

One example embodiment is a method that includes receiving, by a mobile device transceiver from a beacon device, a radio signal including encoded beacon device identifying data. The method then determines, on the mobile device within a mobile device app, whether the beacon device is configured in a backend system for a facility at which the beacon device is deployed. When the beacon device has not been configured, the method includes presenting a beacon device configuration interface within which configuration options are presented and configuration input is received to form configuration data that is stored to the backend system.

Another method embodiment includes receiving a radio signal including encoded beacon device identifying data and determining the beacon device has not been configured in a backend system for a facility. This method may then present and receiving input of configuration options within a mobile device app. The received input may then be stored to the backend system with regard to the beacon device.

Another embodiment is in the form of a system. This system embodiment includes at least one network interface device, at least one processor, at least one memory, and a database storing beacon device configuration data and customer account data. The at least one memory device stores an instruction set that is executable by the at least one processor to perform data processing activities. The data processing activities include receiving, from a mobile device app via the at least one network interface device, a data message including a beacon identifier and customer account identifying data. The data processing activities further include retrieving, from the database, beacon configuration data associated the beacon identifier, the retrieved beacon configuration data including a functional role process identifier. The data processing activities also include triggering execution of the functional role process according to the functional role process identifier and with regard to the customer account of the customer account identifying data.

### BRIEF DESCRIPTION OF THE DRAWINGS

FIG. 1 is a logical block diagram of a system, according to an example embodiment.

FIG. 2 is a user interface illustration, according to an example embodiment.

FIG. 3 is a user interface illustration, according to an example embodiment.

FIG. 4 is a user interface illustration, according to an example embodiment.

FIG. 5 is a user interface illustration, according to an example embodiment.

FIG. 6 is a user interface illustration, according to an example embodiment.

FIG. 7 is a user interface illustration, according to an example embodiment.

FIG. 8 is a block flow diagram of a method, according to an example embodiment.

FIG. 9 is a block diagram of a computing device, according to an example embodiment.

### DETAILED DESCRIPTION

Various embodiments each include at least one of systems, methods, devices, and software for beacon device configuration and monitoring, such as with regard to BLUETOOTH® beacon devices. Such beacon devices may be deployed to enable mobile devices to communicate with other systems in a manner that informs the other systems of their location. The other systems may then perform various functions based on that location and some of those functions may be performed with specific regard to a customer account identified in data also transmitted to the other system, such as a payment function or providing a location-specific coupon among other functions. For such beacon device solutions to be successfully deployed, the other systems, referred to generally herein as backend systems, are configured with regard to each deployed beacon device. To date, this configuration has been performed primarily in a manual manner and has failed to provide a solution that allows local personnel, such as restaurant employees, to perform the configuring.

Further, many environments within which beacon devices may be deployed are susceptible to radio interference. For example, in a restaurant environment, there are many radio signals being transmitted, such as by computer and network equipment, two-way communication radio devices, local WI-FI® routers, and even customer devices. Additionally, large metal items such as carts and appliances may be moved about the environment that may also interfere with radio signals transmitted by beacon devices. As a result, beacon devices often need to be reconfigured or recalibrated based on the dynamic nature of the environments within which they are deployed.

The various embodiments herein provide solutions that enable local personnel to deploy new beacon devices and reconfigure and recalibrate previously deployed beacon devices. Such embodiments generally include a mobile device app that executes on a mobile device. The mobile device app provides user interfaces through which a user selects a location, a beacon device, and configuration options that are then stored in the backend system to enable customer mobile device apps to utilize deployed beacon device solutions. The user interfaces provide guidance to personnel in configuring and calibrating the beacon devices such that the need for specially trained personnel is significantly minimized and perhaps even eliminated.

These are other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

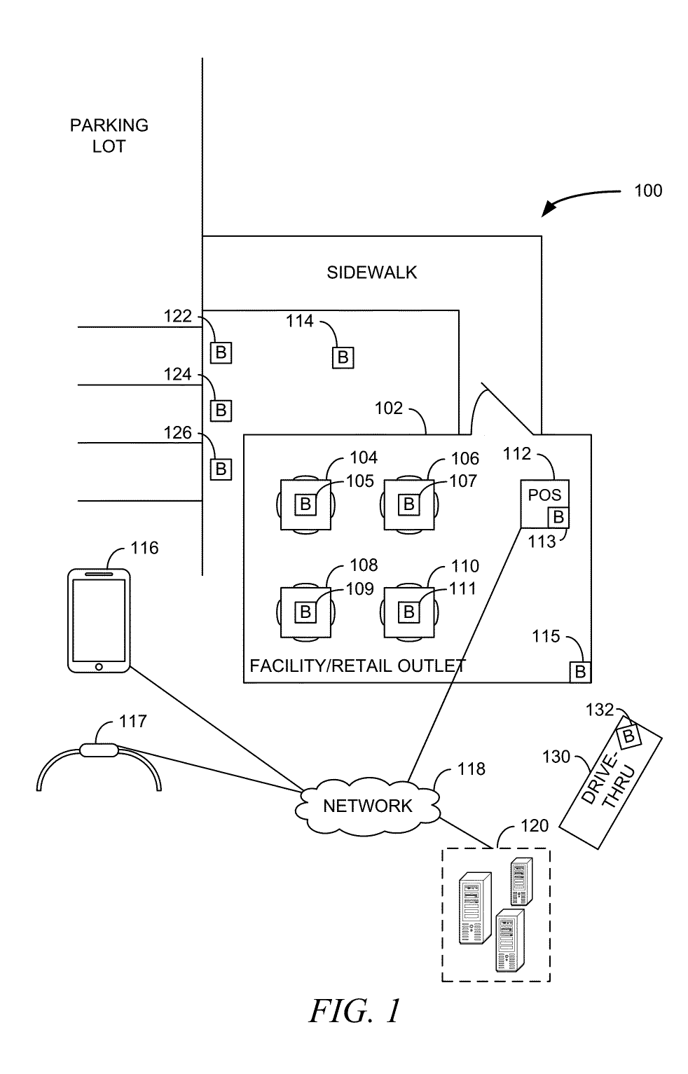

FIG. 1 is a logical block diagram of a system 100, according to an example embodiment. The system 100 is illustrated as deployed with regard to a facility 102, such as a restaurant, although other embodiments may be deployed to other facility types, such as stores, concession stands, casinos, hospitals, and other facility types. The system 100 operates to associate a customer account maintained in a backend computing system 120 with a customer carrying a mobile device 116, 117 having an app of an operator of the facility 102 or other entity providing app and customer services to an operator of the facility 102.

In an example embodiment, a customer carrying a mobile device 116, 117, such as a smartphone, smartwatch, or tablet, enters the facility 102. The customer mobile device 116, 117 typically includes a mobile device app that executes thereon that allows the customer to perform various actions, such as one or more of creating an account, adding and modifying payment account information, viewing and selecting items offered for sale at the facility 102, and to create an order therefore. Some embodiments of the mobile device 116, 117 app may perform additional actions such as viewing receipts of visits or interactions in the facility 102 or other facilities or access points (e.g., websites, kiosks, etc.), viewing a current bill, viewing a facility 102 map, viewing data of appointments and reservations, checking in at the facility with regard to an appointment or reservation, making a payment, and the like. The mobile device 116, 117 app, in some embodiments, receives data received by a transceiver device present on the mobile device 116, 117, such as one or both of a BLUETOOTH® device and a WI-FI® device. In some embodiments, the data may also or alternatively be received via a GPS device of the mobile device 116, 117. An example of data that may be received by the mobile device 116, 117 app is data from one or more beacon devices 105, 107, 109, 111, 113, 114, 115, 122, 124, 126, 132 deployed in and around the facility 102. The data from the one or more beacon devices 105, 107, 109, 111, 113, 114, 115, 122, 124, 126, 132 typically includes identifiers of the respective beacon devices. These beacon device identifiers enable the mobile device 116, 117 app or a backend system 120 service to determine a location of the mobile device. A beacon device identifier included in data transmitted from a mobile device 116, 117 may also trigger performance of one or more data processing activities configured in the backend system 120 with regard to a particular beacon device 105, 107, 109, 111, 113, 114, 115, 122, 124, 126, 132. The mobile device 116, 117, and the app thereon, may receive data from one of the beacon devices 105, 107, 109, 111, 113, 114, 115, 122, 124, 126, 132 or a plurality of beacon devices 105, 107, 109, 111, 113, 114, 115, 122, 124, 126, 132.

In an example embodiment, the beacon devices 105, 107, 109, 111, 113, 114, 115, 122, 124, 126, 132 broadcast a radio signal encoded with identifying data that is registered in the backend system 120 with a known location, such as a point of sale (POS) terminal 112, a table 104, 106, 108, 110, a drive-thru menu board 130, or other location at the particular facility 102. The beacon device, in some embodiments, may include a radio device, such as a BLUETOOTH® beacon device. Among others, such beacon devices are available from NCR Corporation of Duluth, Ga. The beacon device may also, or alternatively, include a WI-FI® Wireless Access Point (WAP) device in some embodiments. The radio signal, or signals, broadcast by the beacon device are received by the mobile device 116, 117 and the mobile device 116, 117 app or the backend system 120 may then determine a location of the mobile device 116, 117 based on one or more of the received signals. The position may also be determined based in part on variable signal strength of each of the one or more signals received by the mobile device 116, 117.

In some embodiments, the mobile device 116, 117 app, upon receipt of positioning data, such as from one or more of the beacon devices 105, 107, 109, 111, 113, 114, 115, 122, 124, 126, 132, assembles and sends a data message to the backend system 120. The data message typically includes the position data, such as one or more received beacon device identifiers, and an identifier of the customer account. The data message may be sent, via a network 118 such as the Internet, to the backend system 120 by calling a web service offered by the backend system 120 or sending a another type of data message or method call depending on the particular embodiment.

The backend system 120 may then associate the received web service or other data message or method call with a customer account based on the customer account identifier. The backend system 120 may also then determine a location of the customer based on the one or more beacon device 105, 107, 109, 111, 113, 114, 115, 122, 124, 126, 132 identifiers. Based on the identified customer account and location or even simply a beacon device identifier and signal strength, one or more data processing activities may then be identified for execution. For example, based on the identified customer account, a query of a backend system 120 database may be made to identify any open orders for which ordered items are awaiting pick up. When one or more open orders awaiting pick up are identified, each of the one or more identified orders may then be transmitted to the facility of the location to be prepared or retrieved for delivery to the customer of the particular account. At the same time, a payment data processing activity may also be triggered with regard to payment data associated with the customer account in the backend system. The items to be picked up may be picked up by customers at a designated location, such as a pick up window or drive thru window, or the pick up location may be a location of the customer, such as when the customer is at the POS terminal 112, a table 104, 106, 108, 110, or other location in the facility 102.

Such solutions may also be integrated with other functionality. For example, if the identified location is with regard to the beacon device 114 as the customer is approaching the facility 102 entrance, a data processing activity may be identified based on a configured association with the particular beacon device 114 and invoked to retrieve customer profile data and an image of the customer from a database and to transmit that data, via the network 118, to POS terminal 112 or other facility 102 computing device located inside the facility 102 near the entrance. This data may then be presented to inform the attendant to greet the customer by name when they see the person represented in the image and to inform them of the status of their order. Similarly, in many restaurants today, customers may order food for pickup with the food being delivered to their car when the park in the parking lot. Thus, the app on the customer's mobile device 116, 117 upon receipt of a signal from one or more of the beacon devices 122, 124, 126 located in designated parking spots in a parking lot, this data may be transmitted to the backend system 120. The backend system 120 may then identify and perform data processing activities with regard to the particular customer when within a configured range of a particular beacon device to identify an open pickup order for curbside delivery. The process may then inform personnel of the facility 102 that the customer has arrived, a listing of their ordered items, their location such as the specific parking spot, and may also provide additional details with regard to their vehicle if the vehicle is included in order or customer profile data. Facility 102 personnel may then promptly prepare their order and deliver the order curbside upon the customer's arrival.

Regardless of the particular data processing activities that may be triggered or the type of facility within which the beacon devices 105, 107, 109, 111, 113, 114, 115, 122, 124, 126, 132 are deployed, the beacon devices 105, 107, 109, 111, 113, 114, 115, 122, 124, 126, 132 are configured and calibrated in the backend system 120 for their intended purposes. Thus, when beacon devices 105, 107, 109, 111, 113, 114, 115, 122, 124, 126, 132 are deployed and as they may need maintenance due to beacon device fatigue or environmental changes, various embodiments include mobile device 116, 117 apps that are utilized to configure and calibrate the beacon devices 105, 107, 109, 111, 113, 114, 115, 122, 124, 126, 132. The mobile device apps communicate via a the network with the backend system 120 to retrieve data with regard to facilities, beacon devices 105, 107, 109, 111, 113, 114, 115, 122, 124, 126, 132 deployed therein, and configurations thereof. The mobile device apps include guided configuration and calibration processes that leverage a transceiver of a mobile device 116, 117 in use to receive radio signals from beacon devices 105, 107, 109, 111, 113, 114, 115, 122, 124, 126, 132, to define their respective configurations and calibrations, and to store this data to the backend system 120. The mobile device apps, in some embodiments, are utilized by facility 102 personnel, such as by managers or supervisors. Some embodiments of the mobile device apps also include functionality that monitors beacon device health and operation in view of a known configuration retrieved by the mobile device app or experience data gathered while roaming the facility 102 and transmitted to the backend system.

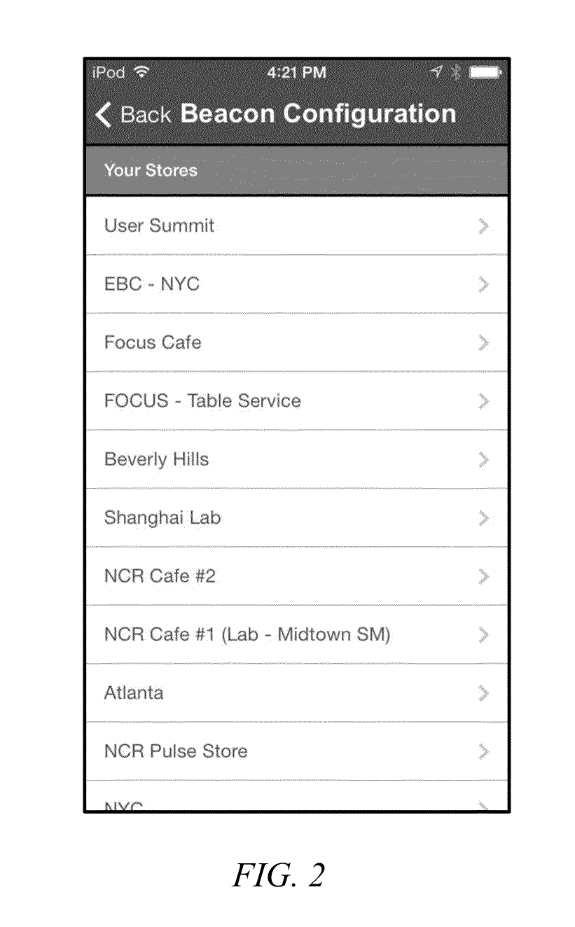

Further details of some such embodiments are described with regard to the following methods and as illustrated in the user interface illustrations of FIG. 2 through FIG. 7.

FIG. 2 through FIG. 7 are user interface illustrations of user interfaces presented by a mobile device app that executes on a mobile device, such as the mobile devices 116, 117 of FIG. 1, to present and receive input with regard beacon device configuration and calibration.

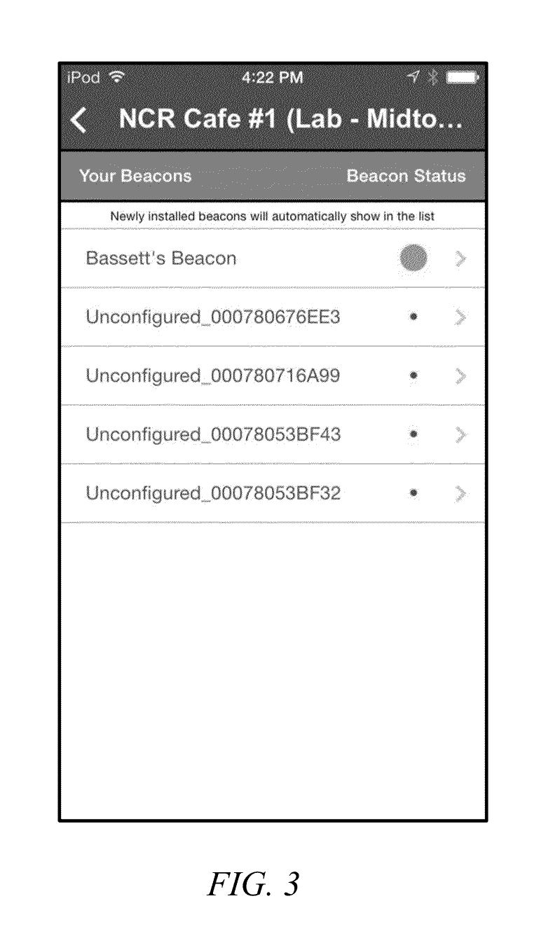

FIG. 2 is a user interface illustration, according to an example embodiment. The user interface of FIG. 2 is presented after a user logs into the mobile device app. The user interface presents a listing of facilities, in this instance stores, the user is allowed to view. The mobile device app retrieves this data from a backend system, such as the backend system 120 of FIG. 1. The user selects a store, such as “NCR Café #1 (Lab—Midtown SM)” and the user interface of FIG. 3 is presented.

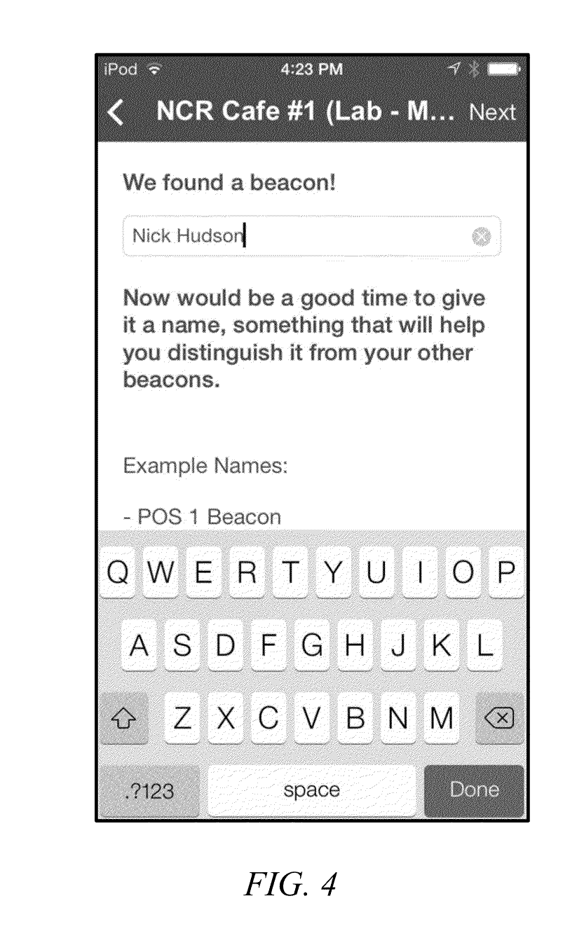

FIG. 3 is a user interface illustration, according to an example embodiment. The user interface of FIG. 3 is presented following a selection of a facility from the user interface of FIG. 2. The user interface of FIG. 3 presents a list of beacon devices previously configured in and retrieved from the backend system. In some instances, not all beacon devices configured in the backend system have been fully configured. Further, by selecting the facility in FIG. 2, the user is setting their current location. Thus, in some embodiments, when an unconfigured beacon device is detected through radio signals received by the mobile device, that beacon device will be added to the configuration data stored by the backend system in association with the previously selected facility. Further, this newly discovered beacon device will be added to the listing of beacon devices in the user interface of FIG. 3. To configure a previously known or a newly discovered beacon device, the user may select a beacon device from the listing in the user interface of FIG. 3. For example, a user may select one of the unconfigured beacon devices from the listing of beacon devices in the user interface of FIG. 3 and the user interface of FIG. 4 will be presented.

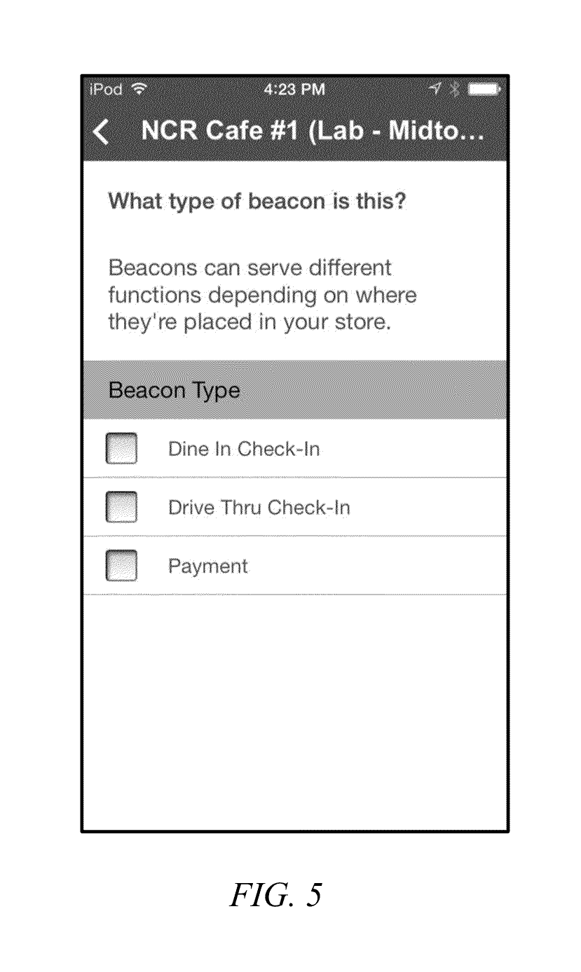

FIG. 4 is a user interface illustration, according to an example embodiment. The user interface of FIG. 4 requests the user to enter or edit a name of the selected beacon. A descriptive naming convention is suggested, but not required. Once the user is satisfied with an entered name, the user may select the DONE button or other user interface control. This will cause the name of the subject beacon device to be updated in the backend system and the user interface of FIG. 5 will then be presented to receive further configuration input.

FIG. 5 is a user interface illustration, according to an example embodiment. The user interface of FIG. 5 provides options to assign various functional roles to the beacon device. The functional roles are generally associated with functionality implemented by executable code in one or more of the backend system, a facility management or transaction system, and user mobile devices. In some embodiments when a functional role option is selected and a beacon device identifier is subsequently received from a customer mobile device, also typically with a customer account identifier, the executable code associated with the assigned functional role is triggered for execution.

The functional role options presented in the user interface of FIG. 5 include “Dine In Check-In”, “Drive Thru Check-In”, and “Payment” functional roles. The executable code associated with these functional roles operates to perform tasks associated therewith. For example, the Payment functional role executes to process a payment according to payment account details included in customer account data. Further, the Dine In Check-In functional role may execute to inform staff that the customer has arrived or to add the customer's name to a dining table waiting list. While the functional role options included in the illustration of FIG. 5 are with regard to a restaurant, the functional role options may vary in different embodiments and be customized and configured to the context of the particular embodiment, such as a hospital or clinic, a casino, a gas station or car wash, a coffee shop, a grocery store and other retail outlets, and the like.

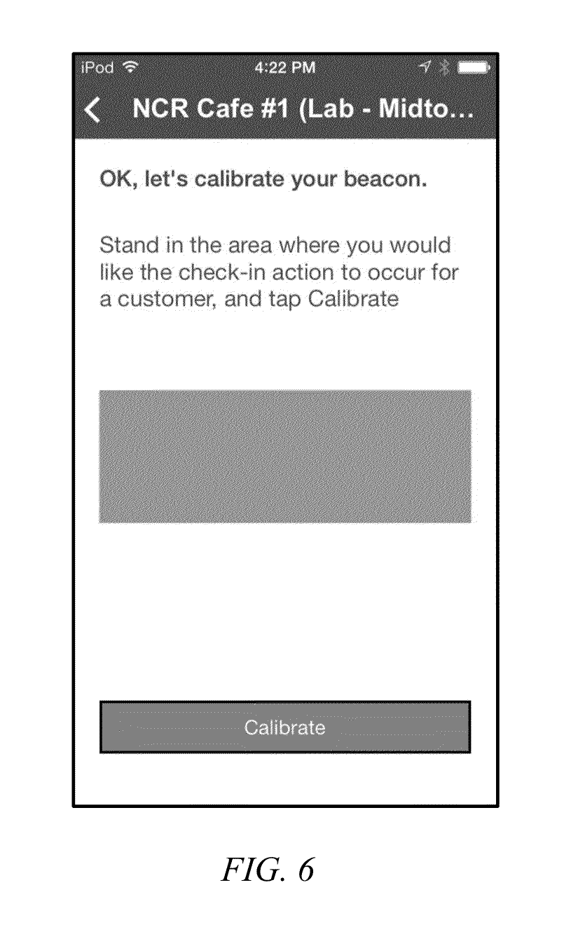

Once a user has selected the desired functional role options in the user interface of FIG. 5, the user may select a user interface control to move to a next step, such as a calibration step facilitated by the user interface illustrated in FIG. 6.

FIG. 6 is a user interface illustration, according to an example embodiment. The user interface of FIG. 6 guides a user through a calibration process with regard to the subject beacon. To begin the calibration process, the user may select a start of CALIBRATE user interface control. The user interface may then instruct the user to move within range of the subject beacon device if not already within range. Further, the user interface may change displayed instructions to instruct the user to move about an area the user desires for the beacon device to be active, meaning area within which the one or more functional roles assigned to the beacon device will be triggered.

While the user interface of FIG. 6 is instructing the user how to move about, a background calibration process is also executing on the mobile device. This background calibration process is receiving radio signals, via a transceiver of the mobile device such as a BLUETOOTH® transceiver. The radio signals may be received from not only the subject beacon device, but also other beacon devices deployed in facility. As the user moves about the facility as instructed within the user interface, the received signals and their variable signal strengths are recorded. This data is utilized to form calibration data that is then stored to the backend system. The backend system stores this calibration data and utilizes this data to evaluate data received from customer mobile device apps to determine whether to trigger execution of any functional roles that might be associated with the subject beacon device or other beacon devices in the facility.

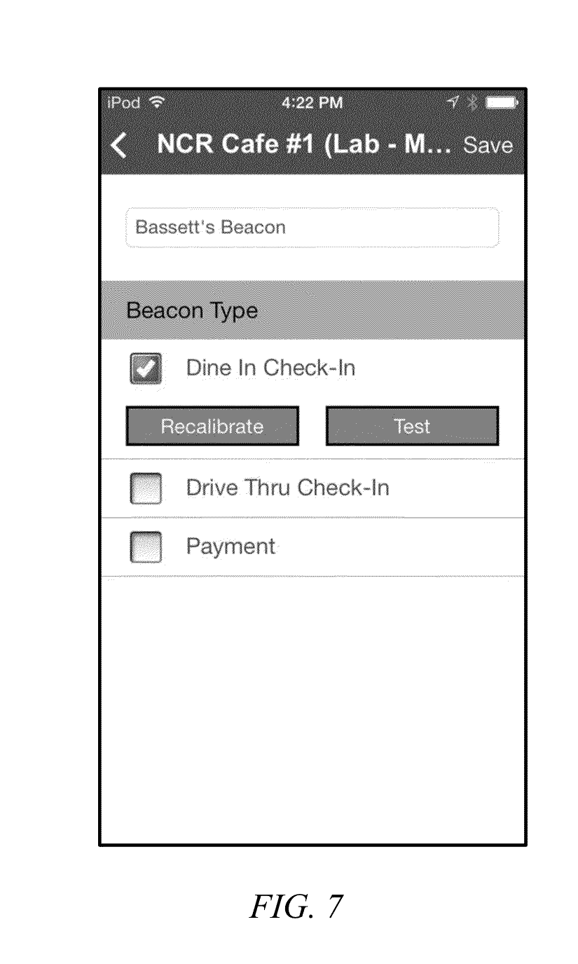

Once background calibration process is complete, the user interface of FIG. 6 presents an indication. The user interface of FIG. 7 may then be presented.

FIG. 7 is a user interface illustration, according to an example embodiment. The user interface of FIG. 7 presents a summary of the subject beacon device configuration. This user interface may be presented following completion of a beacon device configuration and calibration process or upon selection of a beacon device from the listing provided in the user interface of FIG. 3 when the selected beacon device has already been configured. The user interface of FIG. 7 provides options to change a beacon device name, modify assigned functional roles, to recalibration the beacon device, and to test the beacon device. Fewer or more options may be provided in various embodiments.

The user interfaces of FIG. 2 through FIG. 7 are provided as example according to some embodiments. Other or additional user interfaces may be included in some embodiments.

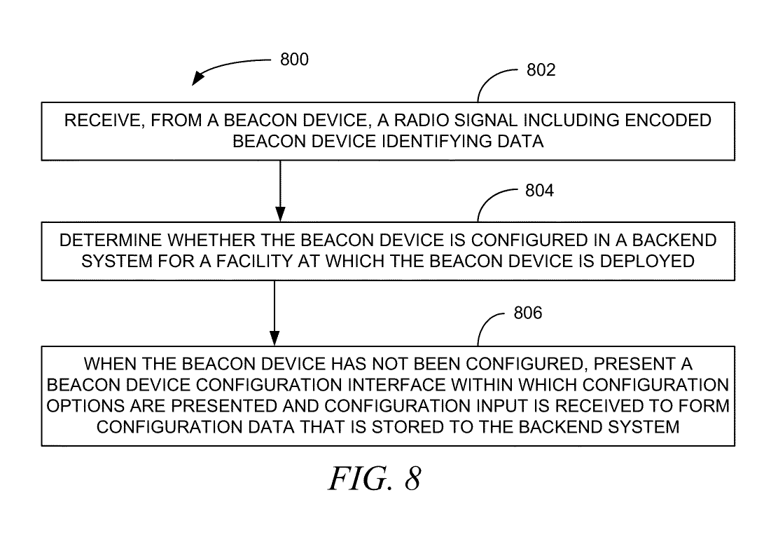

FIG. 8 is a block flow diagram of a method 800, according to an example embodiment. The method 800 is an example of a method that may be performed in whole or in part on a mobile device when configuring and calibrating a beacon device deployed within a facility.

The method 800 includes receiving 802, by a mobile device transceiver from a beacon device, a radio signal including encoded beacon device identifying data. The method 800 then determines 804, on the mobile device within a mobile device app, whether the beacon device is configured in a backend system for a facility at which the beacon device is deployed. This determination may be made based on data retrieved by the mobile app which may or may not be cached in a memory of the mobile device. When the beacon device has not been configured, the method 800 includes presenting 806 a beacon device configuration interface within which configuration options are presented and configuration input is received to form configuration data that is stored to the backend system.

In some embodiments of the method 800, when the beacon device has been configured, an editable view of the beacon device configuration is presented and any received configuration edits are stored to the backend system.

In some embodiments of the method 800, determining 804 whether the beacon device is configured in the backend system includes receiving selection input, within a user interface presented on a display of the mobile device, of the facility, such as within the user interface illustrated in FIG. 2. This embodiment further includes retrieving, via a network from the backend system, at least a portion of beacon configuration data of each beacon configured in the backend system as deployed at the facility. This retrieved data may then be presented, such as within the user interface illustrated in FIG. 3. Based on the received beacon device identifying data, the method may then determine whether the retrieved beacon configuration data includes configuration data for the beacon device of the beacon device identifying data.

In some embodiments, the configuration options presented 806 in the beacon device configuration interface include options to assign functional roles to the beacon device. An example illustration of such a presentation of options is provided in FIG. 5. In such embodiments, each functional role is associated with at least one data processing activity that executes at least in part in the backend system. In some such embodiments, upon receipt of input assigning a functional role to the beacon device, the method further includes presenting a guided beacon device calibration process user interface view on the display of the mobile device. An example of such a user interface is included in the user interface illustration of FIG. 6. In such embodiment and as mentioned previously, while presenting the guided beacon device calibration process user interface view, the method also executes a calibration process on the mobile device to receive radio signals from the mobile device transceiver. These received radio signals have a varying signal strength as the mobile device is moved in relation to the beacon device. These received signals are utilized to generate calibration data specific to the functional role assigned to the beacon device. The generated calibration data is then stored to the backend system in association with the configuration data of the beacon device.

In some embodiments, one functional role that may be associated with a beacon device in configuration data stored in the backend system is a customer check-in functional role that also executes on the backend system. In some embodiments, this check-in functional role executes to receive a first data message via a network from a mobile device app that executes on a mobile device of a customer. The first data message typically includes customer account identifying data and a beacon device identifier of a beacon device deployed to and configured in the backend system in association with the facility. The check-in functional role may further execute to generate and transmit a second data message via the network to at least one computing device located at the facility including customer account identifying data. This second data message may include an instruction to perform a data processing activity on the at least one computing device located at the facility, such as to display or print out a listing of items ordered by the customer, process a payment, to add the customer's name to a waiting list, and the like. The instructions may also trigger a transmission of a data to the customer mobile device including an advertisement, an information document such as a healthcare provider privacy statement, and the like.

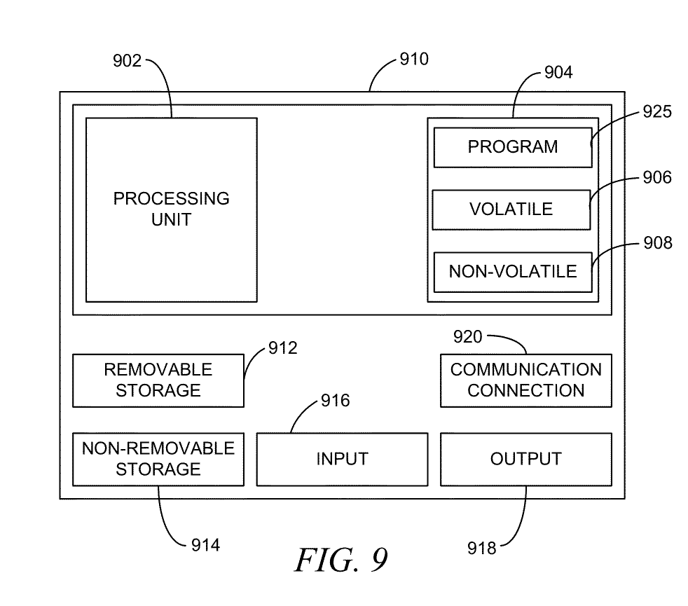

FIG. 9 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 910, may include a processing unit 902, memory 904, removable storage 912, and non-removable storage 914. Although the example computing device is illustrated and described as computer 910, the computing device may be in different forms in different embodiments. For example, the computing device may instead be a smartphone, a tablet, smartwatch, or other computing device including the same or similar elements as illustrated and described with regard to FIG. 9. Devices such as smartphones, tablets, and smartwatches are generally collectively referred to as mobile devices. Further, although the various data storage elements are illustrated as part of the computer 910, the storage may also or alternatively include cloud-based storage accessible via a network, such as the Internet.

Returning to the computer 910, memory 904 may include volatile memory 906 and non-volatile memory 908. Computer 910 may include—or have access to a computing environment that includes a variety of computer-readable media, such as volatile memory 906 and non-volatile memory 908, removable storage 912 and non-removable storage 914. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 910 may include or have access to a computing environment that includes input 916, output 918, and a communication connection 920. The input 916 may include one or more of a touchscreen, touchpad, mouse, keyboard, camera, one or more device-specific buttons, one or more sensors integrated within or coupled via wired or wireless data connections to the computer 910, and other input devices. The computer 910 may operate in a networked environment using a communication connection 920 to connect to one or more remote computers, such as database servers, web servers, and other computing device. An example remote computer may include a personal computer (PC), server, router, network PC, a peer device or other common network node, or the like. The communication connection 920 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 920 may also or alternatively include a transceiver device, such as a BLUETOOTH® device that enables the computer 910 to wirelessly receive data from and transmit data to other BLUETOOTH® devices.

Computer-readable instructions stored on a computer-readable medium are executable by the processing unit 902 of the computer 910. A hard drive (magnetic disk or solid state), CD-ROM, and RAM are some examples of articles including a non-transitory computer-readable medium. For example, various computer programs 925 or apps, such as one or more applications and modules implementing one or more of the methods illustrated and described herein or an app or application that executes on a mobile device or is accessible via a web browser, may be stored on a non-transitory computer-readable medium.

Another system embodiment includes at least one network interface device, at least one processor, at least one memory, and at least one output device, such as a monitor or printer. The at least one memory device stores an instruction set that is executable by the at least one processor to perform data processing activities. The data processing activities include receiving, via the at least one network interface device, order data associated with at least one account and detecting a mobile device present at a retail outlet and associating the mobile device with an account associated with the order data. The data processing activities further include outputting at least a portion of the order data via the at least one output device to facilitate fulfillment of an order of the order data.

In some embodiments, the system further includes a transceiver device that operates as a radio signal beacon to broadcast an identifier registered in the system to the retail outlet. In such embodiments, detecting the mobile device is present at the retail outlet includes receiving, via the at least one network interface device from the mobile device, an identifier of at least one transceiver device deployed at the retail outlet. The data processing activities in such embodiments may further include querying a database of transceiver device identifiers to obtain a retail outlet identifier.

Another system embodiment includes at least one network interface device, at least one processor, at least one memory, and a database storing beacon device configuration data and customer account data. The at least one memory device stores an instruction set that is executable by the at least one processor to perform data processing activities. The data processing activities include receiving, from a mobile device app via the at least one network interface device, a data message including a beacon identifier and customer account identifying data. The data processing activities further include retrieving, from the database, beacon configuration data associated the beacon identifier, the retrieved beacon configuration data including a functional role process identifier. The data processing activities also include triggering execution of the functional role process according to the functional role process identifier and with regard to the customer account of the customer account identifying data.

In some embodiments, the functional role process executes to perform a payment function with regard to payment account data included in the customer account data stored in the database.

In some embodiments, the functional role process includes a beacon tracking process that records data with regard to the beacon identifier included in the received data message. In some such embodiments, the data processing activities further include monitoring data recorded with regard to beacon identifiers included in received data messages in view of stored beacon configuration data to identify possible or actual issues with deployed beacon devices. Upon identification of a possible or actual issue with a deployed beacon device, the data processing activities further include generating and transmitting an issue notification message via the at least one network interface device to a messaging account associated in the beacon device configuration data with the deployed beacon device. This may include one or more of an in-app notification, an email, a text message, and the like.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving, by a mobile device transceiver from a beacon device, a radio signal including encoded beacon device identifying data;
determining, on the mobile device, whether the beacon device is configured in a backend system for a facility at which the beacon device is deployed; and
when the beacon device has not been configured, presenting a beacon device configuration interface within which configuration options are presented and configuration input is received to form configuration data that is stored to the backend system.

2. The method of claim 1, wherein when the beacon device has been configured, presenting an editable view of the beacon device configuration and storing any received configuration edits to the backend system.

3. The method of claim 1, wherein the mobile device transceiver device is a BLUETOOTH® transceiver device.

4. The method of claim 1, wherein determining whether the beacon device is configured in the backend system includes:
receiving selection input, within a user interface presented on a display of the mobile device, of the facility;
retrieving, via a network from the backend system, at least a portion of beacon configuration data of each beacon configured in the backend system as deployed at the facility; and
based on the received beacon device identifying data, determining whether the retrieved beacon configuration data includes configuration data for the beacon device of the beacon device identifying data.

5. The method of claim 1, wherein the configuration options presented in the beacon device configuration interface include options to assign functional roles to the beacon device, each functional role associated with at least one data processing activity that executes at least in part in the backend system.

6. The method of claim 5, wherein upon receipt of input assigning a functional role to the beacon device, the method further comprises:
presenting a guided beacon device calibration process user interface view on the display of the mobile device providing instructions to move the mobile device in relation the beacon device, the instructions tailored to the assigned functional role;
while presenting the guided beacon device calibration process user interface view, executing a calibration process on the mobile device to receive radio signals from the mobile device transceiver, the received radio signals having a varying signal strength as the mobile device is moved in relation to the beacon device to generate calibration data specific to the functional role assigned to the beacon device; and
storing the generated calibration data to the backend system in association with the configuration data of the beacon device.

7. The method of claim 5, wherein one functional role is a customer check-in functional role that executes on the backend system to:
receive a first data message via a network from a mobile device app that executes on a mobile device of a customer, the first data message including customer account identifying data and a beacon device identifier of a beacon device deployed to and configured in the backend system in association with the facility; and
generate and transmit a second data message via the network to at least one computing device located at the facility including customer account identifying data.

8. The method of claim 7, wherein the second data message includes an instruction to perform a data processing activity on the at least one computing device located at the facility.

9. The method of claim 8, wherein the instruction to perform the data processing activity on the at least one at least one computing device located at the facility is an instruction to add the customer of the customer account identifying data to a list of customers awaiting service at the facility.

10. The method of claim 9, wherein the instruction to perform the data processing activity on the at least one at least one computing device located at the facility is an instruction to transmit an advertisement to the mobile device app.

11. A method comprising:
receiving a radio signal including encoded beacon device identifying data;
determining the beacon device has not been configured in a backend system for a facility and presenting and receiving input of configuration options within a mobile device app; and
storing the received input to the backend system with regard to the beacon device.

12. The method of claim 11, wherein determining the beacon device has not been configured in the backend system includes:
receiving selection input of the facility within a user interface of the mobile device app;
retrieving, via a network from the backend system, at least a portion of beacon configuration data of each beacon configured in the backend system as deployed at the facility; and
based on the received beacon device identifying data, determining whether the retrieved beacon configuration data includes configuration data associated with the beacon device identifying data.

13. The method of claim 11, wherein the configuration options presented in the beacon device configuration interface include options to assign functional roles to the beacon device, each functional role associated with at least one data processing activity that executes at least in part in the backend system.

14. The method of claim 13, wherein upon receipt of input assigning a functional role to the beacon device, the method further comprises:
presenting a guided beacon device calibration process user interface view on the display of the mobile device providing instructions to move the mobile device in relation the beacon device, the instructions tailored to the assigned functional role;
while presenting the guided beacon device calibration process user interface view, executing a calibration process on the mobile device to receive radio signals from the mobile device transceiver, the received radio signals having a signal strength as the mobile device is moved in relation to the beacon device to generate calibration data specific to the functional role assigned to the beacon device; and
storing the generated calibration data to the backend system in association with the configuration data of the beacon device.

15. The method of claim 14, wherein the radio signals received from the mobile device transceiver during execution of the calibration process include radio signals received from a plurality of beacon device.

16. The method of claim 13, wherein one functional role is a payment functional role that executes on the backend system to:
receive a first data message via a network from a mobile device app that executes on a mobile device of a customer, the data message including customer account identifying data and a beacon device identifier of a beacon device deployed to and configured in the backend system in association with the facility;
validate a payment according to payment account data stored in association with the customer account identifying data; and
when the payment has been validated, generate and transmit a second data message via the network to a payment processing system associated with the beacon device in beacon device configuration data stored in the backend system.

17. A system comprising:
at least one network interface device;
at least one processor;
at least one memory;
a database storing beacon device configuration data and customer account data; and
an instruction set, stored in memory and executable by the at least one processor to perform data processing activities, the data processing activities comprising:
receiving, from a mobile device app via the at least one network interface device, a data message including a beacon identifier and customer account identifying data;
retrieving, from the database, beacon configuration data associated the beacon identifier, the retrieved beacon configuration data including a functional role process identifier; and
triggering execution of the functional role process according to the functional role process identifier and with regard to the customer account of the customer account identifying data.

18. The system of claim 17, wherein the functional role process executes to perform a payment function with regard to payment account data included in the customer account data stored in the database.

19. The system of claim 17, wherein the functional role process includes a beacon tracking process that records data with regard to the beacon identifier included in the received data message.

20. The system of claim 19, wherein the instruction set is further executable to perform data processing activities comprising:
monitoring data recorded with regard to beacon identifiers included in received data messages in view of stored beacon configuration data to identify possible or actual issues with deployed beacon devices;
upon identification of a possible or actual issue with a deployed beacon device, generating and transmitting an issue notification message via the at least one network interface device to a messaging account associated in the beacon device configuration data with the deployed beacon device.
